(19) United States
(12) Patent Application Publication
(10) Pub. No.: US 2007/0067676 A1
(43) Pub. Date: Mar. 22, 2007

(54) Overheat protection system of CPU and method thereof

(75) Inventor: Kuo-Liang Tsai, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/521,304

(22) Filed: Sep. 15, 2006

(30) Foreign Application Priority Data
Sep. 16, 2005 (TW) 094132137

(51) Int. Cl. G06F 11/00

(52) U.S. Cl. 714/23

(57) ABSTRACT

An overheated protection circuitry for a central processing unit (CPU) is provided, which is used when the working temperature of the CPU is higher than a first preset temperature or a second preset temperature. The CPU and a thermal module send out an abnormal signal respectively to inform a chipset (Southbridge chip) to switch off a power supply. The overheated protection circuitry further includes a control module. The control module may synchronously receive the abnormal signal sent by the CPU and the thermal module and switch off the power supply when the working temperature of the CPU is overheated. Therefore, even though the chipset is breakdown and unable to execute a switch-off power supply action, the control module can take over to execute the action of switching off the power supply.

### CROSS REFERENCE TO RELATED APPLICATIONS

This non-provisional application claims priority under 35 U.S.C. § 119(a) on Patent Application No(s). 094132137 filed in Taiwan, R.O.C. on Sep. 16, 2005, the entire contents of which are hereby incorporated by reference.

### BACKGROUND OF THE INVENTION

1. Field of Invention

The present invention relates to an overheated protection circuitry for central processing unit (CPU), and more particularly, to an overheated protection circuitry capable of switching off a power supply when the working temperature of a CPU is higher Man a preset temperature.

2. Related Art

In the convention, when a CPU is overheated, a power supply of the CPU will be switched off This overheated protection mechanism can be divided into two stages. In the first stage, when the temperature of the CPU reaches to a first preset temperature (usually set 100° C.), the first overheated protection mechanism is activated. Net, when the temperature of the CPU reaches to a second preset temperature (usually set 125° C.), the second overheated protection mechanism is activated, wherein the first preset temperature is lower than the second preset temperature. As shown in FIG. 1, it is a conventional overheated protection circuitry. In the figure, a thermal module p11 is used to receive signals of a thermal sensor (not shown) in the CPU p10 and transmit the signals to a micro processor p12 (usually an embodied processor). The micro processor p12 will compare the signals with the first preset temperature. If the temperature of the. CPU p1 is higher than the first preset temperature, a chipset p13 will be informed (usually a Southbridge chip) by the micro processor. If the micro processor p12 or the chipset p13 is breakdown for unknown reasons, the CPU p10 will inform the chipset p13 when the working temperature of the CPU p10 is higher than the second preset temperature so as to send a switch-off signal to switch off the power supply p14.

The above-mentioned overheated protection mechanisms may switch off the power supply to avoid the CPU being damaged according to overheated temperature; however, if the micro processor or the chipset is breakdown, the function of the overheated protection mechanisms is stopped due to crash, or a void in the solder joint of the connection pin of the CPU or the chipset, the power supply can't not be switched off. In this situation, the CPU will be overheated and then the body of the CPU may be burnt or melted, which cause a safety problem. Therefore, how to switch off the power supply when the processor or the chipset is breakdown becomes an import issue.

### SUMMARY OF THE INVENTION

In view of the above, it is an object of the present invention to provide an overheated protection circuitry for solving the problems that the CPU is damage due to be overheated because the elements used for sending out a signal to switch off a power supply are break down and the elements used for sending out a signal to switch off a power supply have manufacturing defects led to the elements are unable to execute the action of switching off the power supply.

To achieve the object, an overheated protection circuitry for CPU is provided. The overheated protection circuitry for CPU is used to switch off the power supply of the CPU when the working temperature of the CPU is higher than a first preset temperature or a second preset temperature. When the working temperature of the CPU is higher than the second preset temperature, the CPU sends out a first abnormal signal. The first abnormal signal is processed by a chipset and then a first switch-off signal is generated and sent. The power supply is switched off after receiving the first switch-off signal.

The overheated protection circuitry for a CPU of the present invention comprises a thermal module, a control module, and a signal processing module. The thermal module is used for detecting the working temperature of the CPU and sends out the second abnormal signal to the control module when the working temperature of the CPU is higher than the first preset temperature. In addition, the control module sends out a second switch-off signal when receiving one of the first and second abnormal signals. The power supply will be switched off when receiving the first switchoff signal or the second switch-off signal.

Moreover, the control module comprises a first determining circuit, a second determining circuit, and a signal conversion module. The first and second determining circuits are used to receive a first and a second abnormal signal respectively. Then a first and a second determining signal are outputted to the signal conversion module after the first and second abnormal signals are processed by level adjusting and signal determining. The signal conversion module outputs the second switch-off signal to the signal processing module to perform an action of switching off the power supply after receiving one of the first and second determining signals.

In addition, the control module comprises a voltage level adjusting circuit and relative circuits. The voltage level adjusting circuit is used for receiving the first abnormal signal and adjusting the level of the first abnormal signal to be the same with that of the second abnormal signal so as to connect with the second abnormal signal to generate the second switch-off signal. The second switch-off signal is provided to the signal processing module for performing an action of switching off the power supply. Moreover, the overheated protection circuitry for a CPU of the present invention further comprises a micro processor and a chipset. The micro processor synchronously receives the thermal signal corresponding to the working temperature of the CPU from the thermal module. In addition, the micro processor sends out a third abnormal signal when the working temperature of the CPU is higher than the first preset temperature. Then the chipset sends out the first switch-off signal when receiving one of the first and third abnormal signals to the signal processing module to perform the action of switching off the power supply.

The overheated protection circuitry for a CPU of the present invention has following advantages and effect:

The present invention is an overheated protection circuitry for CPU, which provides dual overheated protection mechanism. Moreover, because the overheated protection mechanism is not like the conventional one only utilizing micro processor or chipset for sending signals, the control module of the present invention also can synchronously receive the abnormal signals of temperature to perform the action of switching off the power supply; therefore, the present invention can ensure a CPU not being breakdown or damaged due to overheating.

The features and practice of the preferred embodiments of the present invention will be illustrated below in detail with reference to the drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a block diagram of a conventional overheated protection mechanism for CPU;

FIG. 2 is a block diagram of an overheated protection mechanism for CPU according to the present invention;

FIG. 3 is a schematic diagram of a control module of a first embodiment of the present invention;

FIG. 4 is a schematic diagram of a control module of a second embodiment of the present invention; and

FIG. 5 is a schematic diagram of a voltage level adjusting circuit according to the present invention.

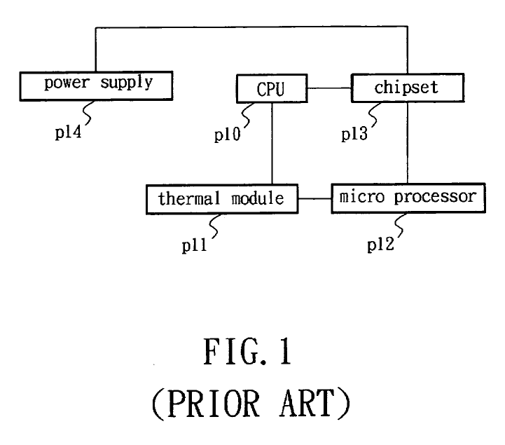

### DETAILED DESCRIPTION OF THE INVENTION

The contents of the present invention are described in details through specific embodiments with reference to the figures. The reference numerals mentioned in the specification correspond to equivalent reference numerals in the figures.

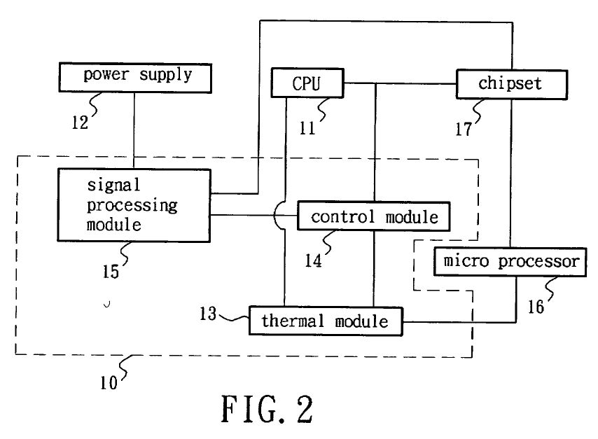

As shown in FIG. 2, it is an overheated protection circuitry 10 for a central processing unit (CPU) 11. The overheated protection circuitry 10 is used to switch off a power supply 12 of the CPU 11 when the working temperature of the CPU 11 is higher than a first preset temperature or a second preset temperature. The power supply 12 is used to supply electrical power to the CPU 11 and other circuits. In addition, the second preset temperature is higher than the first preset temperature. In practice, the second preset temperature is set 125° C. and the first preset temperature is set 0100° C. The CPU 11 has a thermal sensor (not shown) for detecting the working temperature of the CPU 11. When the working temperature of the CPU 11 is higher than the second preset temperature, the CPU 11 sends a first abnormal signal to a chipset 17. The chipset 17 sends out a first switch-off signal to a signal processing module 15, and then the signal processing module 15 switches off the power supply 12 after receiving the first abnormal signal In practice, the first switch-off signal may be a level signal. For example, high level represents the state of switch-off and low level represents the state of switch-on. Therefore, the power supply 17 is switched off by the signal processing module when receiving the first switch-off signal and the first switch-off signal is in the high level. On the contrary, high level may represent the state of switch-on and low level may represent the state of switch-off. Hence, the power supply 17 switches off when receiving the first switch-off signal and the first switch-off signal is in the low level.

The overheated protection circuitry 10 for a CPU of the present invention comprises a thermal module 13, a control module 14, and a signal processing module 15. The thermal module 13 is connected with the thermal sensor of the CPU 11 for detecting the working temperature of the CPU 11. The CPU 11 generates the first abnormal signal to the control module 14 when the working temperature of the CPU 11 is higher than the first preset temperature.

In addition, the control module 14 is connected with the CPU 11 and the thermal module 13, and the thermal module 13 sends out a second abnormal signal when the working temperature of the CPU 11 is higher than the first preset temperature; therefore, the control module 14 is used to receive the first and second abnormal signals, and when receives one of the first and second abnormal signals, the control module 14 sends out a second switch-off signal to the signal processing module 15. The signal processing module 15 switches off the power supply 12 when receiving the first switch-off signal or the second switch-off signal. The above-mentioned first and second abnormal signals may be a level signal in practice. In other word, when the working temperature of CPU is normal, the abnormal signal is a low level signal, for instance 0V. On the other hand, when the working temperature of CPU is abnormal, the abnormal signal is a high level signal, for instance 3.3V or 1V. Therefore, the control module 14 determines the level of the received first and second abnormal signals. If one of the first and second abnormal signals is in high level, the control module 14 generates the second switch-off signal provided to the signal processing module 15. The signal processing module 15 may an OR gate. If one of the first and second switch-off signals is in high level, the power supply switches off

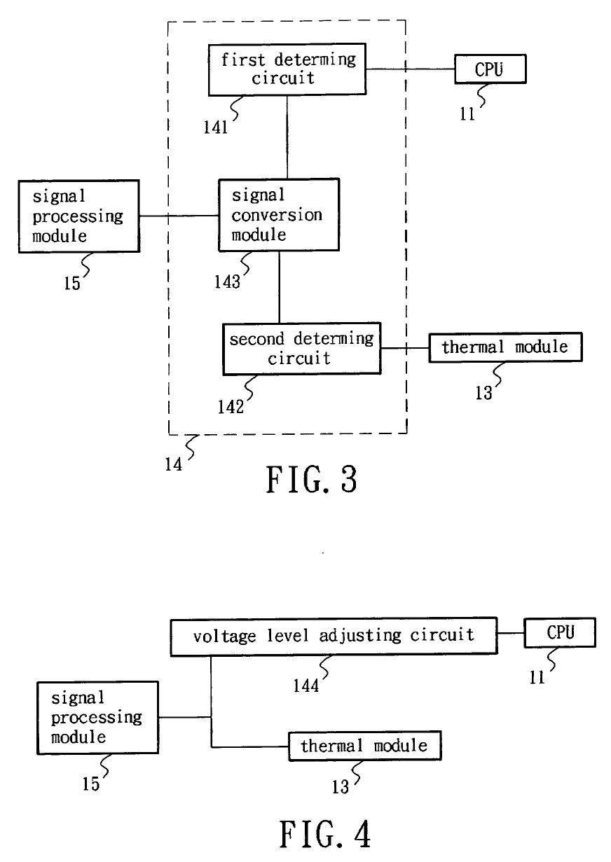

As shown in FIG. 3, it is the control module 14 of a first embodiment of the present invention. In the figure, it can be seen that the control module 14 comprises a first determining circuit 141, a second determining circuit 142, and a signal conversion module 143. The first determining circuit 141 is connected to the CPU 11 for receiving the first abnormal signal and outputs a first determining signal to the signal conversion module 143. The second determining circuit 142 is connected to the thermal module 13 and used for receiving the second abnormal signal. The second determining circuit 142 outputs a second determining signal to the signal conversion module 143 when receiving the second abnormal signal. In addition, except receiving the first and second determining signals, the signal conversion module 143 further outputs the second switch-off signal to the signal processing module 15 when receiving one of the first and second determining signals. Here, the determining signal may be a level signal in practice, and the level of the first determining signal may be the same as that of the second determining signal so as to convert the first and second determining signals to the second switch-off signal when the signal conversion module 143 is an OR gate. Besides, the first determining circuit 141 and the second determining circuit 142 may not be the same because the levels of the first and second abnormal signals are not the same. For instance, if the high level of the first abnormal signal is 1V but the high level of the second abnormal signal is 3.3V, the first determining circuit 141 and the second determining circuit 142 are not the same. However, it is to be noted that the level of the first and second determining signals must be the same in order to match up the conversion of the signal conversion module 143. If the levels of the first and second determining signals are different, they need to be converted in the signal conversion module.

As shown in FIG. 4, it is the control module 14 of a second embodiment of the present invention. In the figure, a voltage level adjusting circuit 144 receives a first abnormal signal sent by the CPU 1. The voltage level adjusting circuit 144 adjusts the level of the first abnormal signal to be the same with the second abnormal signal and the adjusted first abnormal signal is connected with the second abnormal signal so as to generate a second switch-off signal; therefore, in this embodiment, the signal conversion module 143 in the first embodiment can be omitted This embodiment may apply to the conditions when the level of the first abnormal signal outputted by the CPU 11 is 1V, the level of the second abnormal signal outputted by the thermal module 13 is 3.3V, and the second abnormal signal is an open drain pin which can generate an open drain signal. The voltage level adjusting circuit 144 can be used to adjust the level of the first abnormal signal, so that the level of the first abnormal signal, can be the same as that of the second abnormal signal, and the first and second abnormal signals can be connected to be the second switch-off signal. Therefore, except the second determining circuit 142 can be omitted, the signal conversion module 143 can be omitted too.

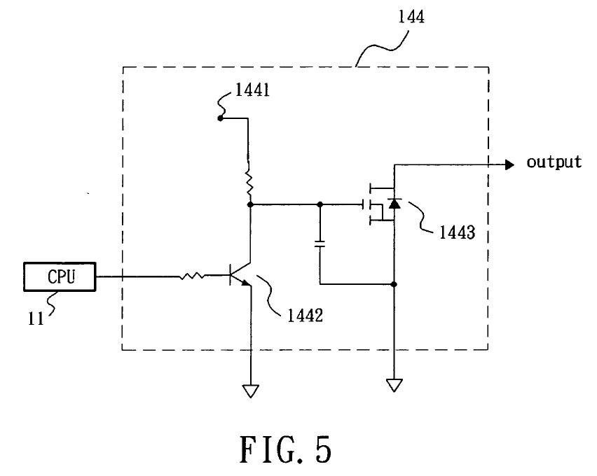

As shown in FIG. 5, it is a diagram of the circuit of the level adjusting circuit 144 of the present invention In the figure, it can be seen that through inputting level reference signal 1441 and the first abnormal signal sent by the CPU, then they are configured and adjusted by a transistor 1442 and a MOSFET 1443 so as to obtain the potential level as same as that of the second abnormal signal which is then outputted to the signal processing module 15.

Referring to FIG. 2 the thermal module 13 further outputs a thermal signal corresponding to the working temperature of the CPU 11 to a micro processor 16. After receiving the thermal signal the micro processor 16 converts the thermal signal into a temperature corresponding to the working temperature of the CPU 11. When the temperature is higher than the first preset temperature, a third abnormal signal is sent to the chipset 17. In addition, when receiving one of the first abnormal signal and third abnormal signal, the chipset 17 sends out the first switch-off signal to the power supply 12. The chipset 17 may be a Southbridge chip and the micro processor 16 is an embedded processor.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An overheated protection circuitry for a central processing unit (CPU), being used to switch off a power supply of the CPU when working temperature of the CPU being higher than a first preset temperature or a second preset temperature, wherein the second preset temperature being higher than the first preset temperature, the CPU sending out a first abnormal signal when the working temperature of the CPU being higher than the second preset temperature, the power supply switching off after receiving a first switch-off signal, comprising:
a thermal module, detecting the working temperature of the CPU, and sending out a second abnormal signal when the working temperature of the CPU being higher than the first preset temperature;
a control module, receiving the first abnormal signal and the second abnormal signal, and sending out a second switch-off signal when receiving one of the first abnormal signal and the second abnormal signal; and
a signal processing module, receiving the first switch-off signal and the second switch-off signal and switching off the power supply when receiving one of the first switch-off signal and the second switch-off signal.

2. The overheated protection circuitry as claimed in claim 1, wherein the control module comprising:
a first determining circuit, receiving the first abnormal signal and outputting a first determining signal when receiving the first abnormal signal;
a second determining circuit, receiving the second abnormal signal, and
outputting a second determining signal when receiving the second abnormal signal; and
a signal conversion module, receiving the first and second determining signals and outputting the second switch-off signal when receiving one of the first and second determining signals.

3. The overheated protection circuitry as claimed in claim 2, wherein potential level of the first determining signal is the same as that of the second determining signal.

4. The overheated protection circuitry as claimed in claim 2, wherein the signal conversion module is an OR gate.

5. The overheated protection circuitry as claimed in claim 1, wherein the control module comprises a potential level adjusting circuit receiving the first abnormal signal and adjusting potential level of the first abnormal signal equal to that of the second abnormal signal, and connecting with the second abnormal signal to form the second switch-off signal.

6. The overheated protection circuitry as claimed in claim 5, wherein the second abnormal signal is an open drain signal.

7. The overheated protection circuitry as claimed in claim 1, wherein the signal processing module is an OR gate.

8. The overheated protection circuitry as claimed in claim 1, wherein the thermal module further outputs a thermal signal corresponding to the working temperature of the CPU, the overheated protection circuitry further including:
a micro processor, receiving the thermal signal, and sending out a third abnormal signal when the working temperature of the CPU being higher than the first preset temperature; and
a chipset, receiving the abnormal signal and the third abnormal signal and sending out the first switch-off signal when receiving one of the first abnormal signal and the third abnormal signal

9. The overheated protection circuitry as claimed in claim 8, wherein the chipset is a Southbridge chip.
